(19) United States
(12) Patent Application Publication
(10) Pub. No.: US 2004/0108379 A1
(43) Pub. Date: Jun. 10, 2004

(54) Combined barcode management method

(76) Inventor: Chih-Hung Chien, Tao-Yuan Hsien (TW)

Correspondence Address: BIRCH STEWART KOLASCH & BIRCH, PO BOX 747, FALLS CHURCH, VA, 22040-0747, US

(21) Appl. No.: 10/315,014

(22) Filed: Dec. 10, 2002

(51) Int. Cl. G06K 15/00; G06F 17/60; G06K 7/10

(52) U.S. Cl. 235/385; 235/383

(57) ABSTRACT

This specification discloses a barcode management method for automatic warehousing. It is a new barcode control mechanism. For commodities that require fixed locators but have no physical barcodes, the invention provides a virtual barcode management method to provide the functions of product in-and-out control and tracking in the same way as real barcodes.

### BACKGROUND OF THE INVENTION

Field of Invention

The invention relates to a barcode management method and, in particular, to a combined barcode management method for automatic warehousing.

Related Art

Currently, most of the retailers or product distributors use barcode recognition systems to manage the in and out of commodities. The barcode represents the universal serial number of a commodity. Read by a scanner, a computer can decode the barcode and converts the lined symbol into a number. The purpose of using the barcode is to facilitate automatic management of the fabrication, wholesale and retail processes. Nowadays, the commodity barcode system is managed by an international organization. Each member country is assigned and authorized with a distinct set of codes for the use of the manufacturers, wholesalers, and retailers inside the country. Since the country code and the manufacturer code are unique, the barcode of each product can be made also unique. Therefore, the barcode is said to be the universal serial code of the commodities.

The barcode system exists because of its special role in commercial activities. Due to the variations of locators, the two-bin system, and no fixed packaging specifications, the barcode control often only manages part of the commodities. Products without any barcode have to be registered separately. Thus, the warehouse records cannot be easily integrated and the management efficiency becomes low. Even if the conventional material requirement planning (MRP) is used for management, it still makes the data identification difficult and, moreover, the system cannot be integrated. Therefore, it is highly desirable to find an easy and convenient method to solve this problem.

### SUMMARY OF THE INVENTION

In view of the foregoing, the invention provides a combined barcode management method. The new barcode management mechanism helps integrating the commodity management. Commodities that require fixed locators but have no physical barcodes are given virtual barcodes. Therefore, the invention can provide the functions of in-and-out control and tracking in the same way as real barcodes.

The disclosed combined barcode management method has the following procedure. First, a commodity is received and, after knowing the attribute of the commodity, assigned with a locator. If the commodity does not have a physical barcode, it is given a temporary virtual barcode. Once the commodity is given a barcode, it is put away into its locator. The virtual barcode is also registered in the system for management. Finally, the inventory data of the locator are updated.

During the period of moving commodities out of their locators, when the personnel is assigned with a picking list commodities are selected according to the numbers and barcodes on the list. If the quantity of a commodity with a virtual barcode is the same as the required quantity on the list, the data associated with the virtual barcode are removed. Finally, the inventory data of the locator are adjusted and updated.

### BRIEF DESCRIPTION OF THE DRAWINGS

The invention will become more fully understood from the detailed description given hereinbelow illustration only, and thus are not limitative of the present invention, and wherein:

FIG. 1 is a flowchart of receiving commodities according to the disclosed method; and

FIG. 2 is a flowchart of picking commodities according to the disclosed method.

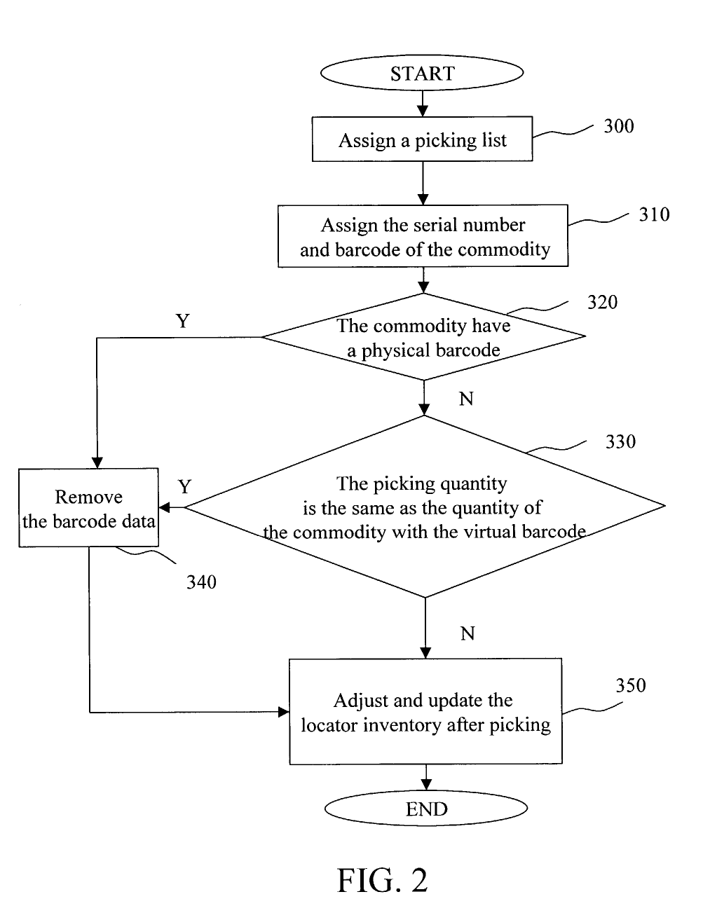

### DETAILED DESCRIPTION OF THE INVENTION

The invention provides a combined barcode management method. This method provides a virtual barcode management method for commodities that require fixed locators but do not have physical barcodes. It achieves the functions of in-and-out control and tracking in the same way as real barcodes.

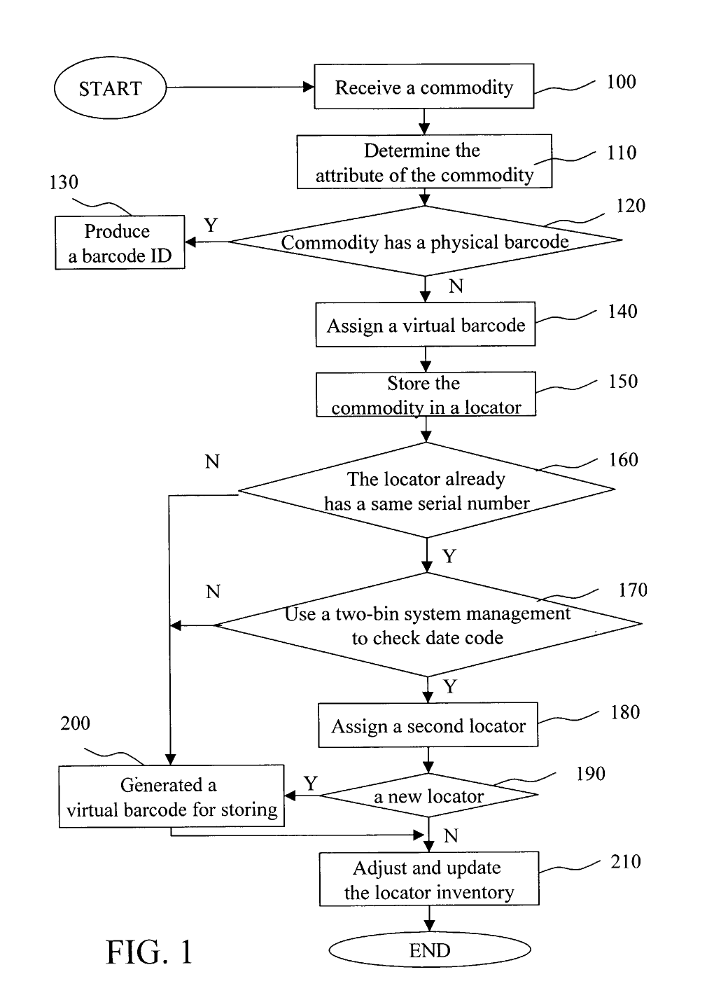

A preferred embodiment is used below to demonstrate the feasibility of the disclosed method. FIG. 1 shows a material reception flowchart of the combined barcode management method.

Since the in-and-out of materials change very frequently, the corresponding warehouse recording is also very complicated. This increases the difficulty in integrating the system. For the material reception operation, after the warehouse receives a commodity (step 100), the warehouse personnel have to first check its attribute (step 110) and then determine whether there is a physical barcode for the commodity (step 120). If the commodity already has a physical barcode with the information of country, manufacturer and serial number, then the information of the commodity is entered into the warehouse management system. After checking all detailed items in the information of the commodity, it is registered and a barcode ID if produced (step 130). If the commodity does not have a physical barcode, a virtual barcode is assigned to the commodity according to the information of supplier, quantity, etc of the commodity (step 140). Afterwards, tags written with relevant information are manually attached onto the commodity. The virtual barcode is temporarily assigned according to the locator, commodity, and ownership. After each commodity obtains its barcode for filing, the commodity is then stored in the locator (step 150). However, before storing the commodity in the locator, one has to first check whether there are already commodities with the same barcodes in the locator (step 160). If not, the virtual barcode for storing is directly produced (step 200); otherwise, one further uses a two-bin management system to check date code (step 170). If date code is the different, then the virtual barcode is directly produced (step 200); otherwise, if date code is the same, a second locator is assigned (step 180). The so-called two-bin system is to store the same commodity in two locators, which are used to control the storing and ordering operations. Therefore, when the commodities in the first locator are depleted, one is still left with commodities in the second locator. One may also adopt the first-in-first-out (FIFO) management to avoid the drawback of using color or manual management as in the prior art. If the second locator is not stored with any commodity, then the system determines whether it is a new locator (step 190). If it is a new locator, then the new virtual barcode is generated (step 200). After the commodities are stored, the locator inventory is adjusted and updated (step 210). If it is not a new locator, then the locator inventory is directly updated (step 210). After being processed by the combined barcode management method of the invention, each of the received commodities has a unique barcode for registering and recording the commodity in the warehouse information system.

When there are commodities to be shipped, one starts with the picking operation. First, the warehouse personnel produce a picking list according to a fixed procedure (step 300) and assign the serial numbers barcodes to the picking personnel (step 310). When determining the picking list, one has to know first whether a particular commodity has a physical barcode (step 320). If there is a physical barcode, the barcode data are removed after the picking operation is completed (step 340). If not, then the commodity has a virtual barcode. The system further determines whether the picking quantity is the same as the inventory quantity (step 330). If they are the same, the barcode data are removed once the picking operation is completed (step 340). After the picking personnel finish the picking operation, the locator inventory is adjusted and updated (step 350). If the quantities are not the same, the locator inventory is adjusted and updated after the picking operation is completed (step 350).

The virtual barcode proposed by the invention is different from the physical barcode. The number of virtual barcodes can be increased and decreased. After commodities are shipped or moved out of the warehouse, the virtual barcode data can be removed/deleted. Therefore, the warehouse information management system can simultaneously monitor the physical barcodes and the virtual barcodes. The storage and presentation of the warehouse data can be made more detailed and consistent. This allows a flexible management. The virtual barcodes according to the invention can incorporate any installed barcode systems without building a new system to manage commodities without barcodes.

Effects of the Invention

Through the analysis of the disclosed combined barcode management method, one finds that the method has the following advantages:

1. The commodity data input can speed up, increasing the operation efficiency and lowering the management cost.

2. The existing operational process can be improved to exactly monitor where commodities are by use of the barcodes.

3. Commodities originally without barcodes can still be integrated into the information system, or even the POS, electronic ordering systems (EOS), and transportation and warehouse automation systems.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A combined barcode management method for the commodity reception operation of a warehouse system, the method comprising the steps of:
outputting reception data of a commodity and checking the attribute thereof;
determining whether the commodity is one with a barcode or one without a barcode;
obtaining the barcode of the commodity with a barcode and assigning the commodity without a barcode a virtual barcode; and
storing the commodity to a locator, registering the commodity in the warehouse system under the virtual barcode, and adjusting and updating the locator inventory.

2. The method of claim 1, wherein the barcode is a physical barcode.

3. The method of claim 1, wherein the virtual barcode is generated according to the serial number and the locator data of the commodity.

4. A combined barcode management method for a picking operation in a warehouse system, the method comprising the steps of:
producing a picking list;
assigning a serial number and a barcode of the commodity to be picked for the picking personnel;
removing the barcode data when the picking quantity is the same as the inventory quantity; and
adjusting and updating a locator inventory.

5. The method of claim 4, wherein the step of removing the barcode data when the picking quantity is the same as the inventory quantity further comprises the steps of:
removing a physical barcode record after picking; and
removing a virtual barcode record when the picking quantity is the same as the inventory quantity.

6. The method of claim 4, wherein the barcode is a physical barcode.

7. The method of claim 4, wherein the barcode is a virtual barcode.

8. The method of claim 4, wherein the virtual barcode is generated according to the serial number and the locator data of the commodity.
